(19) United States
(12) Patent Application Publication
(10) Pub. No.: US 2006/0109227 A1
(43) Pub. Date: May 25, 2006

(54) Source driver, gate driver, and liquid crystal display device implementing non-inversion output

(76) Inventor: Hyun-sang Park, Seongnam-si (KR)

Correspondence Address: HARNESS, DICKEY & PIERCE, P.L.C., P.O. BOX 8910, RESTON, VA, 20195, US

(21) Appl. No.: 11/185,824

(22) Filed: Jul. 21, 2005

(30) Foreign Application Priority Data
Nov. 24, 2004 (KR) 10-2004-0097049

(51) Int. Cl. G09G 3/36

(52) U.S. Cl. 345/98

(57) ABSTRACT

A source driver and a gate driver for implementing a non-inversion output characteristic of a liquid crystal display device. The liquid crystal display device may include, a liquid crystal panel including pixels, each pixel including TFT transistors connected to different source lines and different gate lines, a source driver which receives fixed image signals of different polarities and control signals and applies the fixed image signals of different polarities to the different source lines, respectively, and a gate driver which receives control signals and alternately drives the different gate lines for each frame.

### BACKGROUND OF THE INVENTION

This application claims priority of Korean Patent Application No. 10-2004-97049, filed on Nov. 24, 2004, in the Korean Intellectual Property Office, the disclosure of which is incorporated herein in its entirety by reference.

### FIELD OF THE INVENTION

Example embodiments of the present invention relate to a liquid crystal display device, and more particularly, to a liquid crystal display device with a non-inversion output characteristic.

### DESCRIPTION OF THE RELATED ART

FIG. 1 is a view schematically showing the configuration of a conventional liquid crystal display device 100. Referring to FIG. 1, the liquid crystal display device 100 may include a source driver 10 and a gate driver 20 for controlling on/off operations of pixels, a control circuit 40 for controlling the source driver 10 and the gate driver 20, and a panel 30 in which a plurality of pixels are arranged. In the liquid crystal display device 100, a voltage applied to each pixel must be inverted. Because parasitic charges may be generated due to deterioration of liquid crystal substances or alignment layers if an electric field with the same polarity is applied for an extended time, voltage inversion may be needed to reduce or prevent display deterioration, for example image persistence.

To reduce or prevent deterioration of pixels, if voltages of different polarities are alternately applied to the respective pixels for each frame, flicker may be generated in the panel 30 due to differences in brightness of the applied different polarities. To reduce flicker, a row-inversion driving method, a column-inversion driving method, a dot-inversion driving method, etc. may be used. In a row-inversion method, a liquid crystal display device may be driven such that neighboring gate lines have different polarities from each other. In a column-inversion method, a liquid crystal display device may be driven such that neighboring data lines have different polarities from each other. A dot-inversion method may combine a row-inversion method and a column-inversion method, and a liquid crystal display device may be driven such that the upper, lower, left, and right dots of a center dot have different polarities from the center dot.

The above-mentioned conventional driving methods try to reduce a difference between a brightness average of dots in a given area and that of dots in other areas using a principle that human's eyes recognize many dots at the same time. Generally, dot-inversion driving methods are well known as an effective method with little or no inconvenience to users and are most widely used as an inversion driving method of a liquid crystal display device.

A conventional dot-inversion driving method is described in more details with reference to FIGS. 2a and 2b below. Referring to FIGS. 2a and 2b, according to a dot-inversion driving method, voltages of different polarities are applied to respective source lines (Y1, . . . , Yj−1, Yj, Yj+1) for each horizontal period or for each vertical period in such a manner that a voltage is applied to a corresponding pixel. Because neighboring source lines have opposite polarities to each other, a decoder may be shared by adjacent source lines to increase efficiency and accordingly, the source driver 10 may include a multiplexer.

FIGS. 3a and 3b illustrate a conventional source driver 10. The source driver 10 may include a data register unit 51, a data multiplexer 52, a level shifter unit 53, a decoder unit 54, an output multiplexer 55, and an amplifier unit 56. The data register unit 51 stores image signals and the data multiplexer 52 multiplexes the image signals using a first polarity control signal POL_LV and transmits the resultant image signals to the level shifter unit 53. The level shifter unit 53 controls output levels of the image signals and provides the resultant image signals to the decoder unit 54. The decoder unit 54 decodes the image signals. The decoded image signals may be amplified by the amplifier unit 56 via the output multiplexer 55 and then provided to source lines, according to a second polarity control signal POL_HV.

In this example, each of the source lines provides a positive image signal and a negative image signal and shares the decoder unit 54. More particularly, a pair of source lines Yk and Yk+1 share the decoder unit 54. Also, the image signals pass through different decoders according to the first and second polarity control signals POL_LV and POL_HV based on the polarities of the image signals. Referring to FIG. 3a, in a N-th frame, if a negative (−) image signal is provided to the Yk source line and a positive (+) image signal is provided to the Yk+1 source line, the negative (−) image signal is applied to the Yk source line via a N-decoder N-DEC for processing negative image signals in the decoder unit 54 and the positive (+) image signal is applied to the Yk+1 source line via a P-decoder P-DEC for processing positive image signals in the decoder unit 54. Thereafter, referring to FIG. 3b, in a (N+1)-th frame, a positive (+) image signal to be applied to the Yk source line changes its path in the data multiplexer 52, passes through the P-decoder P-DEC for processing the positive (+) image signals, again changes its path in the output multiplexer 55, and then applied to the Yk source line. The amplifier unit 56 may include amplifiers capable of processing both positive (+) image signals and negative (−) image signals.

However, in this conventional technique, because the data multiplexer 52 and the output multiplexer 55 are be included in the source driver 10, the chip area of the source driver 10 increases. Also, because polarity inversion of a voltage to be applied to a source line is needed, current consumption increases and/or a heat generation problem may occur.

### SUMMARY OF THE INVENTION

Example embodiments of the present invention provide a liquid crystal display device with a non-inversion output characteristic.

Example embodiments of the present invention provide a liquid crystal panel with a non-inversion output characteristic.

Example embodiments of the present invention provide a source driver for driving a liquid crystal panel with non-inversion output characteristic.

Example embodiments of the present invention provide a gate driver for driving a liquid crystal panel with a non-inversion output characteristic.

An example embodiment of the present invention is directed to a source driver for driving a liquid crystal panel with a non-inversion output characteristic including a non-inversion data register unit storing n image signals in response to first and second control signals; and a non-inversion decoder unit decoding the n image signals and providing the decoded image signals to source lines of the liquid crystal panel. The source driver may further include a non-inversion level shifter for shifting a level of an output voltage of the non-inversion data register and providing the shifted result to the non-inversion decoder. The non-inversion data register unit may store the n image signals from a second non-inversion data register to a (n+1)-th non-inversion data register in response to the first control signal, and may store the n image signals from a first non-inversion data register to a n-th non-inversion data register in response to the second control signal. The non-inversion decoder unit may include decoders connected respectively to the source lines, wherein decoders connected to even-th source lines of the source lines decode the n image signals with a first polarity voltage and decoders connected to odd-th source lines of the source lines decode the n image signals with a second polarity voltage.

Another example embodiment of the present invention is directed to a gate driver for driving a liquid crystal panel with a non-inversion output characteristic including a non-inversion shift register unit storing first and second control signals; and a non-inversion output buffer unit driving gate lines of the liquid crystal panel in response to the first control signal or the second control signal. The gate driver may further include a non-inversion level shifter for shifting a level of an output voltage of the non-inversion shift register unit and providing the shifted result to the non-inversion output buffer unit. The first control signal and the second control signal may be alternately stored in the shift register unit per each frame which is displayed to the liquid crystal panel.

Another example embodiment of the present invention is directed to a liquid crystal display device with a non-inversion output characteristic including a liquid crystal panel further including a plurality of source lines, a plurality of gate lines, and pixels located at intersections of the source lines and the gate lines, a non-inversion source driver supplying fixed image signals of different polarities respectively to the source lines in response to a first control signal and a second control signal, and a non-inversion gate driver driving the gate lines in response to the first control signal and the second control signal. Each pixel may include one or more transistors, for example, TFT transistors whose drains may be connected in common to a pixel electrode, whose sources may be connected to one or more source lines, and whose gates may be connected to one or more gate lines.

Example embodiments of the present invention permit a data multiplexer and/or an output multiplexer for inverting the polarities of voltages to be applied to source lines to be omitted. As a result, it is possible to implement a source driver with a simpler circuit configuration and/or reduce an entire chip area. Also, according to example embodiments of the present invention, a source driver may provide constant image signals to source lines, thereby reducing power consumption and/or heat generation.

### BRIEF DESCRIPTION OF THE DRAWINGS

The present invention will become more apparent by describing in detail example embodiments thereof with reference to the attached drawings in which:

FIG. 1 is a view schematically showing the configuration of a conventional liquid crystal display device;

FIGS. 2A and 2B are views for explaining a dot-inversion driving method;

FIGS. 3A and 3B illustrate a conventional source driver;

FIGS. 4A and 4B are views for explaining a non-inversion dot display method according to an example embodiment of the present invention;

FIGS. 5A through 5C are views for explaining the non-inversion dot display method according to an example embodiment of the present invention;

FIGS. 6A and 6B are block diagrams showing a source driver according to an example embodiment of the present invention;

FIG. 7 is a view for explaining the operation of the source driver shown in FIGS. 6A and 6B according to an example embodiment of the present invention;

FIG. 8 is a block diagram of a gate driver according to an example embodiment of the present invention; and

FIG. 9 is a timing diagram of main signals used when the source driver and the gate driver according to an example embodiment of the present invention operate.

### DETAILED DESCRIPTION OF EXAMPLE EMBODIMENTS OF THE INVENTION

Hereinafter, example embodiments of the present invention will be described in detail with reference to the appended drawings. Like reference numbers refer to like components throughout the drawings.

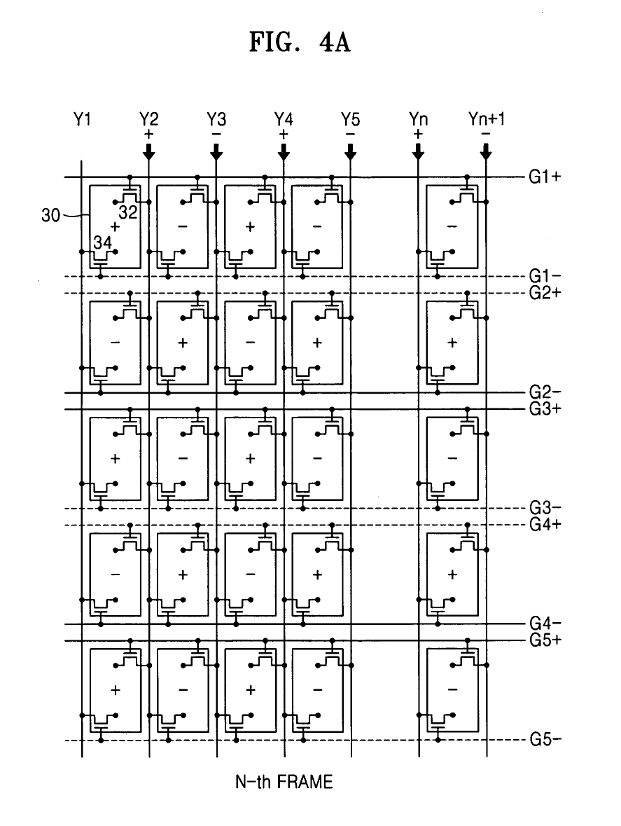

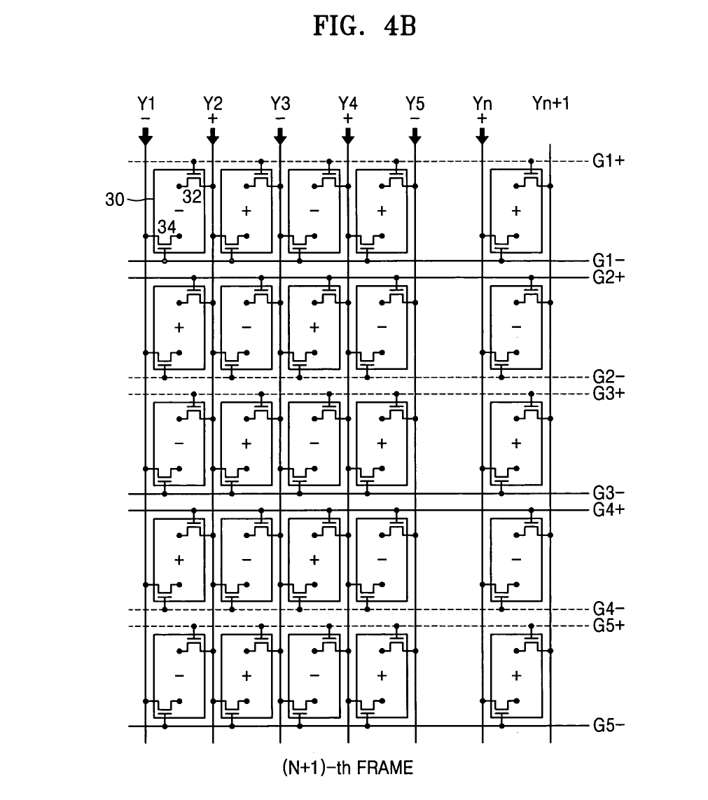

FIGS. 4A and 4B are views for explaining a non-inversion dot display method according to an example embodiment of the present invention, wherein FIG. 4A is a view for explaining a display aspect in a N-th frame and FIG. 4b is a view for explaining a display aspect in a (N+1)-th frame. Referring to FIG. 4a, each pixel 30 may include first and second transistors 32 and 34 for controlling on/off operations of the pixel 30. Two gate lines may be allocated to each pixel 30: a G1+ gate line connected to the first transistor 32, which is selected when a positive (+) polarity image signal is applied to the pixel 30; and a G1− gate line connected to the second transistor 34, which is selected when a negative (−) polarity image signal is applied to the pixel 30.

In an example embodiment, the polarities of respective source lines Y1 through Yn+1 are fixed. For example, a negative (−) image signal may be applied to the odd-th source lines (Y1, Y3, Y5, . . . ) and a positive (+) image signal may be applied to the even-th source lines (Y2, Y4, Y6, . . . ). The final source line Yn+1 may provide the inverse polarity of the previous source line Yn. In order to change the polarity of an image signal to be provided to each pixel per every frame, referring to FIG. 4a, in a N-th frame, gate lines G1+, G2−, G3+, G4−, and G5+ may be sequentially selected. Thereafter, in a (N+1)-th frame, referring to FIG. 4b, gate lines G1−, G2+, G3−, G4+, and G5− may be sequentially selected. In other example embodiments, the polarities may be reversed.

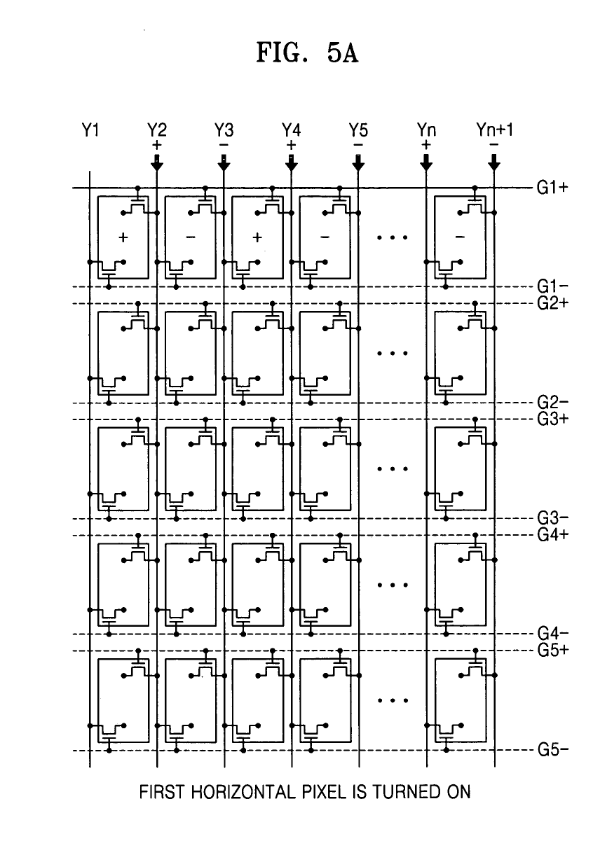

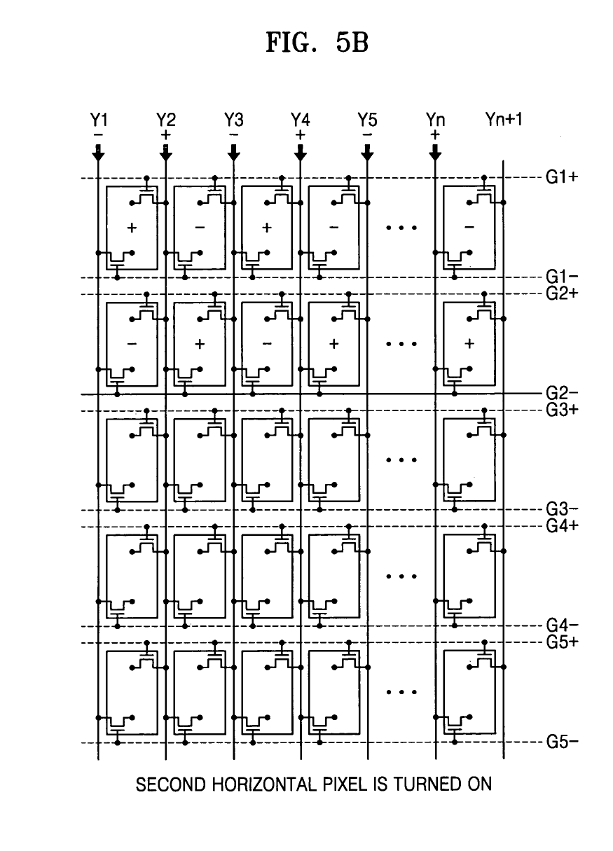

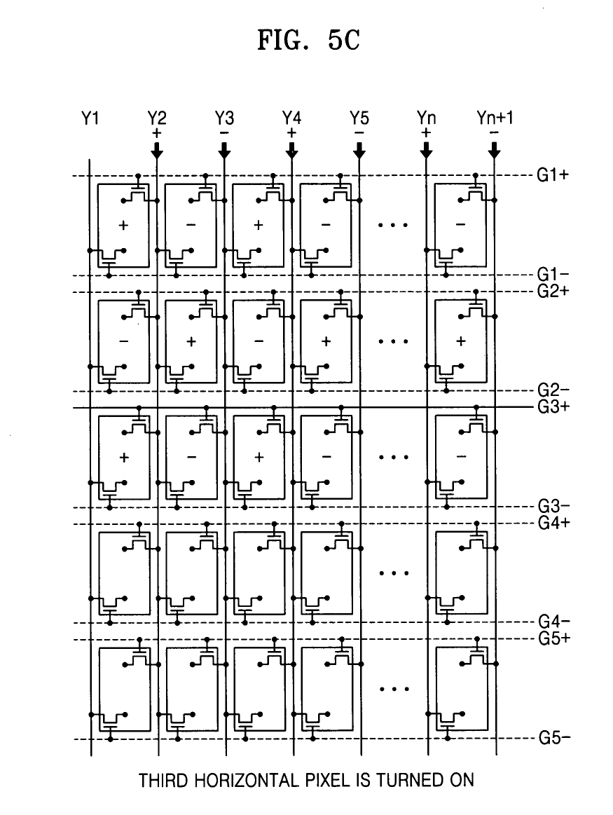

FIGS. 5A through 5C are views for explaining an example embodiment of a non-inversion dot display method. Referring to FIG. 5A, in order to turn on pixels of a first horizontal row in the N-th frame, the G1+ gate line may be selected. A positive (+) image signal may be applied to the Y2 source line, a negative (−) image signal may be applied to the Y3 source line, and a positive (+) image signal may be applied to the Y4 source line, etc. Accordingly, the pixels of the first horizontal row may be sequentially charged with polarities of +, −, +, −, . . . Referring to FIG. 5B, in order to turn on pixels of a second horizontal row, the G2− gate line may be selected. In this case, likewise, a positive (+) image signal may be applied to the Y2 source line and a negative (−) image signal may be applied to the Y3 source line, etc. Additionally, a negative (+) image signal may be applied to the Y1 source line and a negative (−) image signal may be applied to the Yn+1 source line. Thus, the pixels of the second horizontal row may be sequentially charged with polarities of −, +, −, +, . . . As shown, the Y2 source line may provide only a positive (+) image signal to the pixels of the first horizontal row or to the pixels of the second horizontal row. Referring to FIG. 5C, in order to turn on pixels of a third horizontal row, the G3+ gate line may be selected. In this case, likewise, a positive (+) image signal may be applied to the Y2 source line, a negative (−) image signal may be applied to the Y3 source line, and a positive (+) image signal may be applied to the Y4 source line, etc. Accordingly, the pixels of the third horizontal row may be sequentially charged with polarities of +, −, +, −, . . . The above-described process may be repeated until pixels of a final horizontal row are all charged.

Returning to FIG. 4B, in the (N+1)-th frame, in order to turn on the pixels of the first horizontal row, the G1− gate line may be selected and the pixels of the first horizontal row may be sequentially charged with polarities of −, +, −, +, . . . In order to turn on pixels of the second horizontal row, the G2+ gate line may be selected and the pixels of the second horizontal row may be sequentially charged with polarities of +, −, +, −, . . . . In the (N+1)-th frame, likewise, a positive (+) image signal may be applied to the Y2 source line and a negative (−) image signal may be applied to the Y3 source line. Therefore, by selecting source lines and gate lines as described above, it is possible to implement dot-inversion.

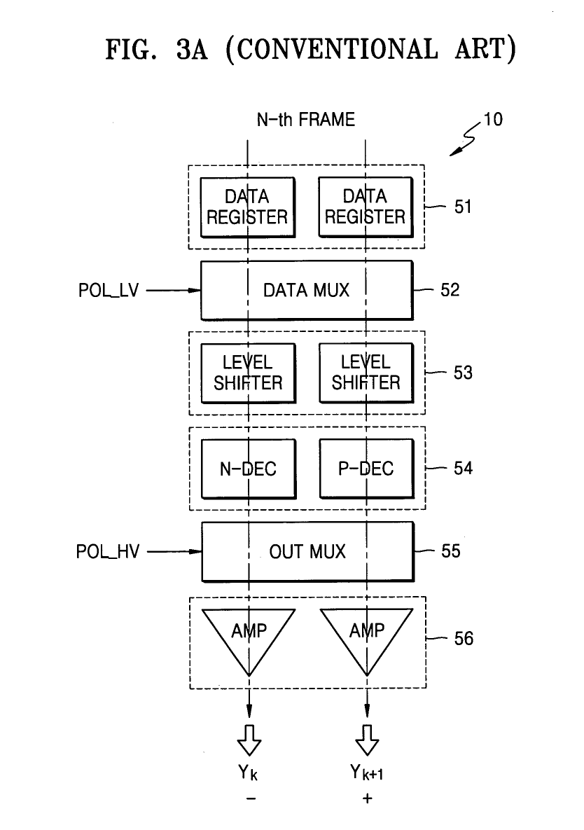

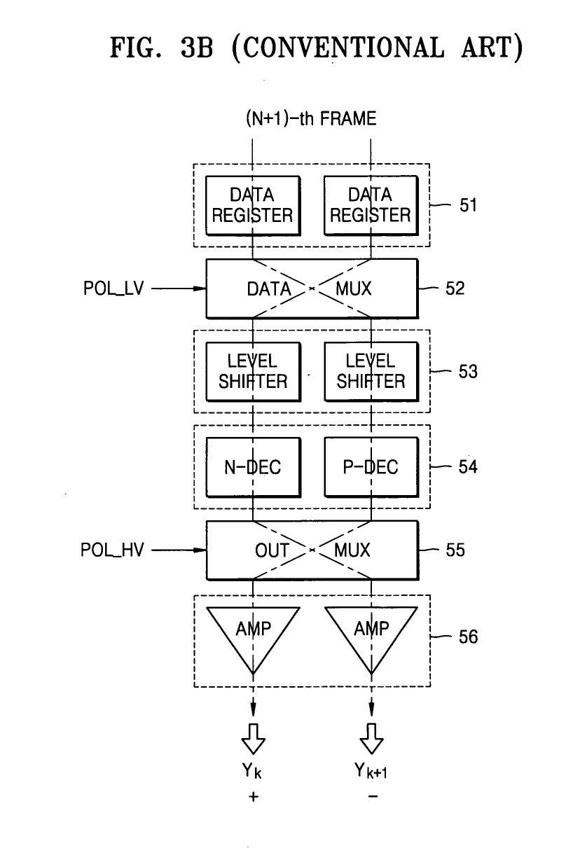

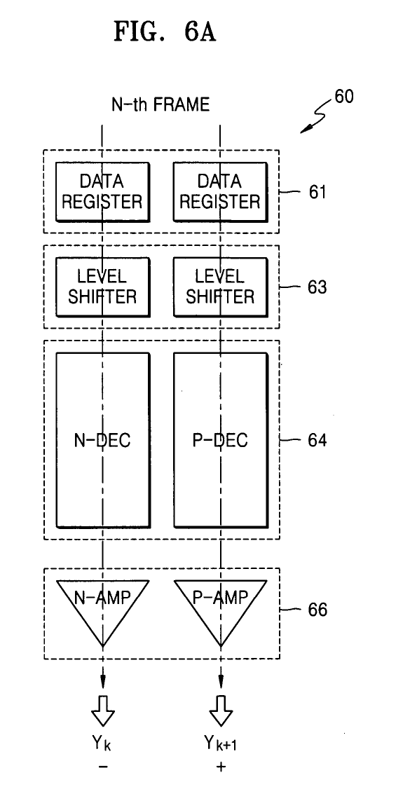

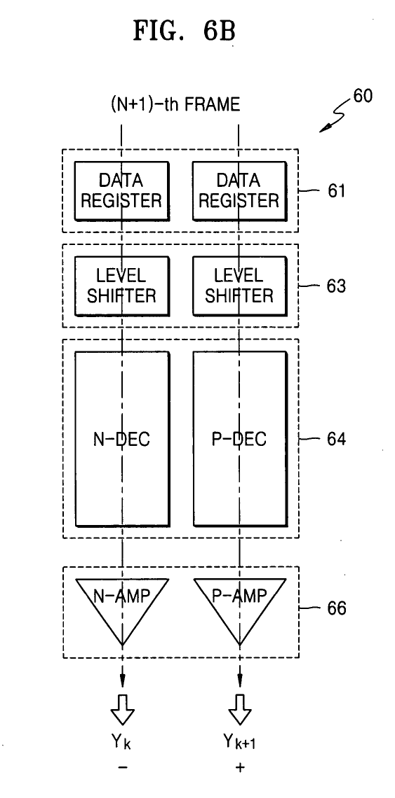

FIGS. 6A and 6B are block diagrams showing a source driver 60 according to an example embodiment of the present invention. The source driver 60 may include a data register unit 61, a level shifter unit 63, a decoder unit 64, and an amplifier unit 66. The data register unit 61 may store image signals, the level shifter unit 63 may control output levels of the image signals, and the decoder unit 64 may decode the image signals. The decoded image signals may be amplified by an amplifier unit 67 and applied to source lines Yk and Yk+1. In an example embodiment of the present invention, a negative (−) image signal may be applied to the source line Yk and a positive (+) image signal may be applied to the source line Yk+1. Therefore, it may be unnecessary to change paths of image signals and accordingly, the data multiplexer 52 and the output multiplexer 55 used in the conventional source driver 10 (FIGS. 3A and 3B) may not be required. As a result, it may be possible to reduce the chip area of the source driver 60. Also, each amplifier of the amplifier unit 66 need amplify only one of a positive (+) image signal and a negative (−) image signal, the amplifier may have a smaller size and allow more precise control than a conventional amplifier unit, for example, amplifier unit 56.

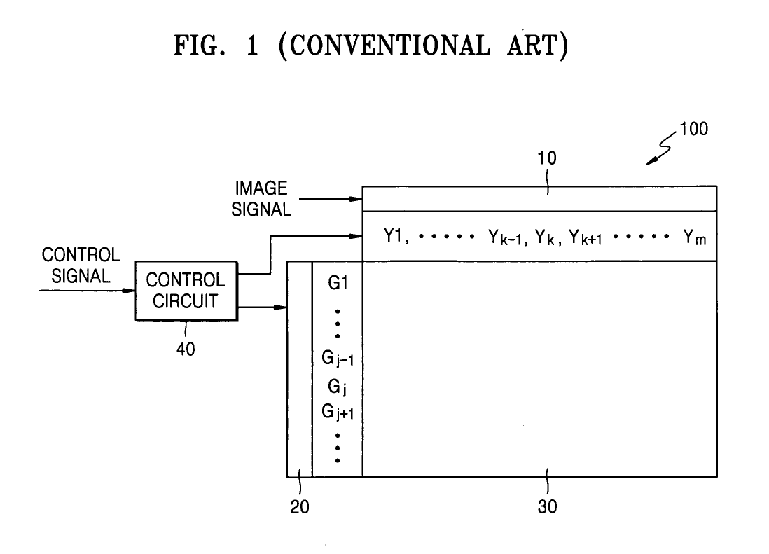

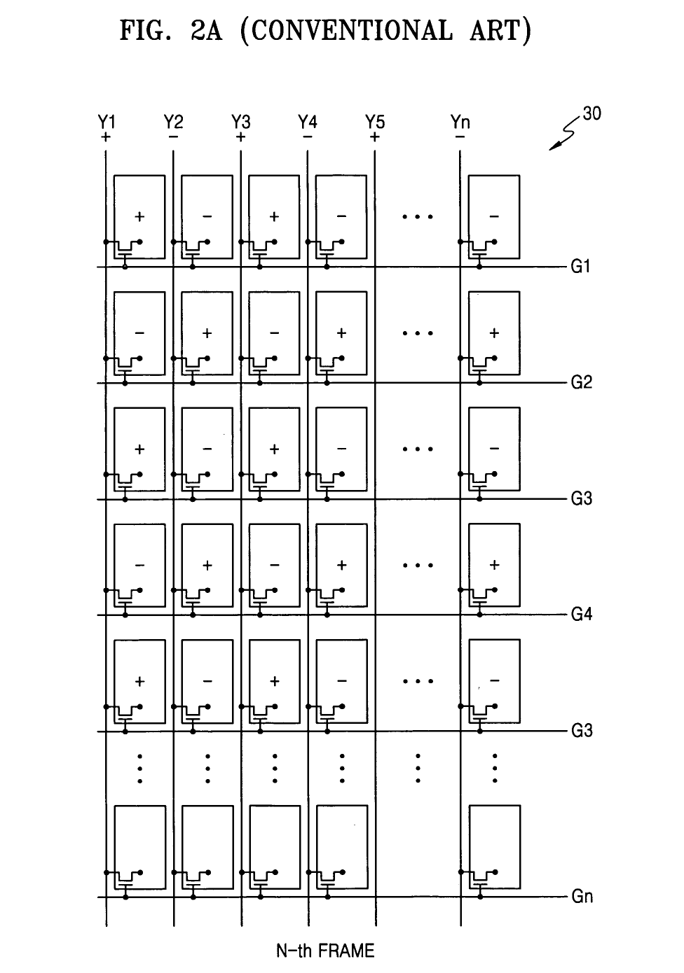

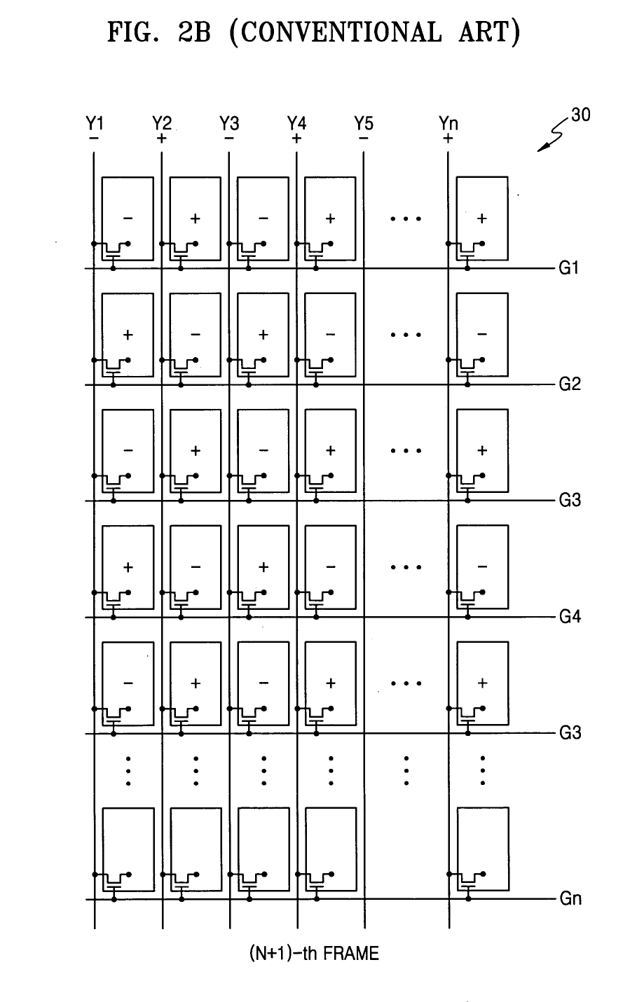

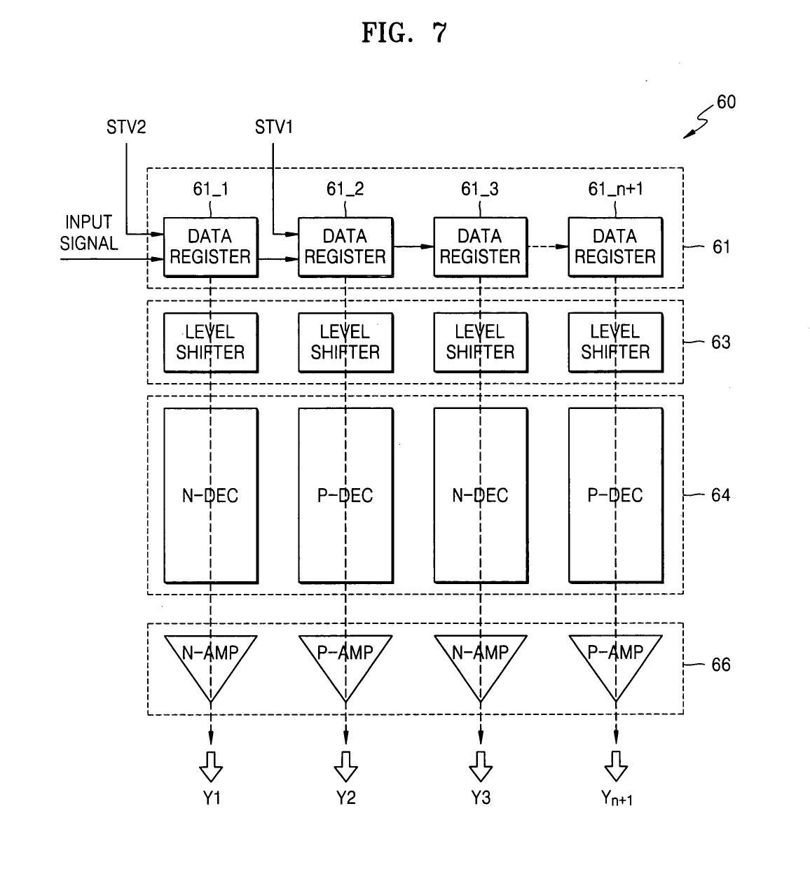

FIG. 7 is a view for explaining the operation of the source driver 60 shown in FIGS. 6A and 6B according to an example embodiment of the present invention. In an example embodiment, it may be assumed that a negative (−) image signal is applied to the Y1 source line, a positive (+) image signal is applied to the Y2 source line, and a negative (−) image signal is applied to the Y3 source line, etc. In another example embodiment, the polarities may be reversed. Referring to FIG. 7, a negative (−) image signal may be provided to pixels of a first vertical row through a Y1 source line and a positive (+) image signal may be provided to the pixels of the first vertical row through a Y2 source line. Also, a positive (+) image signal may be provided to pixels of a second vertical row through the Y2 source line and a negative (−) image signal may be provided to the pixels of the second vertical row through a Y3 source line. The positive (+) or negative (−) image signal may be applied to the pixels of a corresponding vertical row through one of two source lines (for example, source lines Y2 and Y3), according to a first or second frame start signal STV1 or STV2 provided from a control circuit (for example, control circuit 40 of FIG. 1). That is, if a first frame start signal STV1 is applied, image signals may be stored from a second data register 61_2 to a final (N+1)-th data register 61_n+1, and then applied to the pixels of corresponding vertical rows through the Y2 through Yn+1 source lines. Also, if a second frame start signal STV2 is applied, image signals may be stored from a first data register 61_1 to a N-th data register 61_n and then applied to the pixels of corresponding vertical rows through the Y1 through Yn source lines.

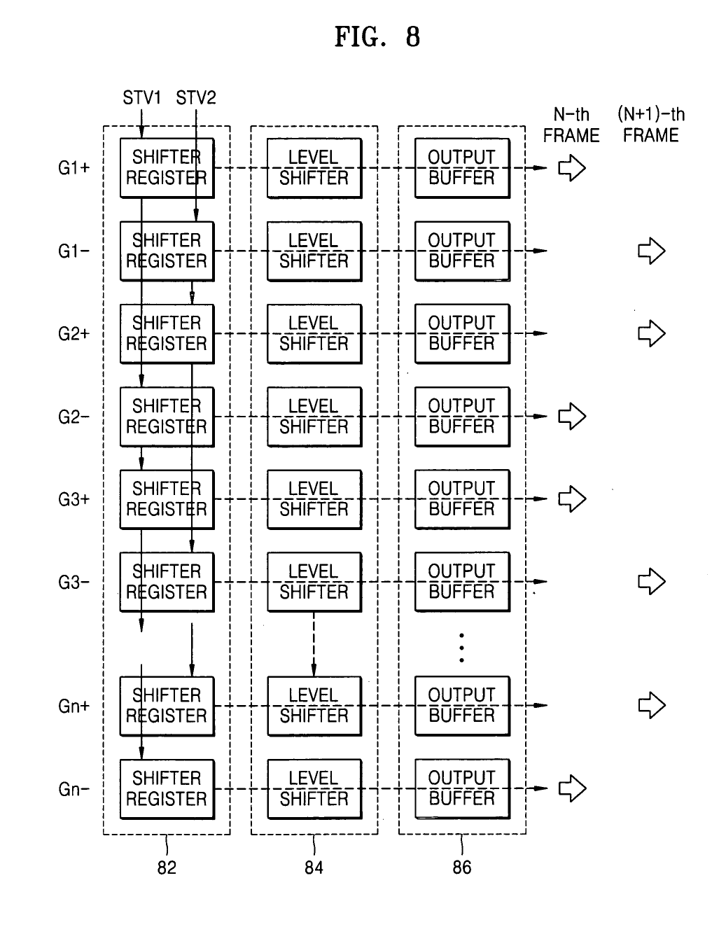

FIG. 8 is a block diagram of a gate driver according to an example embodiment of the present invention. The gate driver 80 may include a shift register unit 82, a level shifter unit 84, and an output buffer unit 86. The shifter register unit 82 receives, stores, and outputs the first frame start signal STV1 or the second frame start signal STV2. The first frame start signal STV1 may be sequentially stored in shifter registers of the shifter register unit 82 connected respectively to gate lines G1+, G2−, G3+, G4−, . . . and the second frame start signal STV2 may be sequentially stored in shifter registers of the shifter register unit 82 connected respectively to gate lines G1−, G2+, G3−, G4+, . . . The levels of the signals stored in the shifter register unit 82 may be changed in by the level shifter unit 84 and provided to corresponding gate lines via the output buffer unit 86. In this manner, in a N-th frame, gate lines G1+, G2−, G3+, G4−, . . . , Gn− are selected, and, in a (N+1)-th frame, gate lines G1−, G2+, G3−, G4+, . . . , Gn+ are selected.

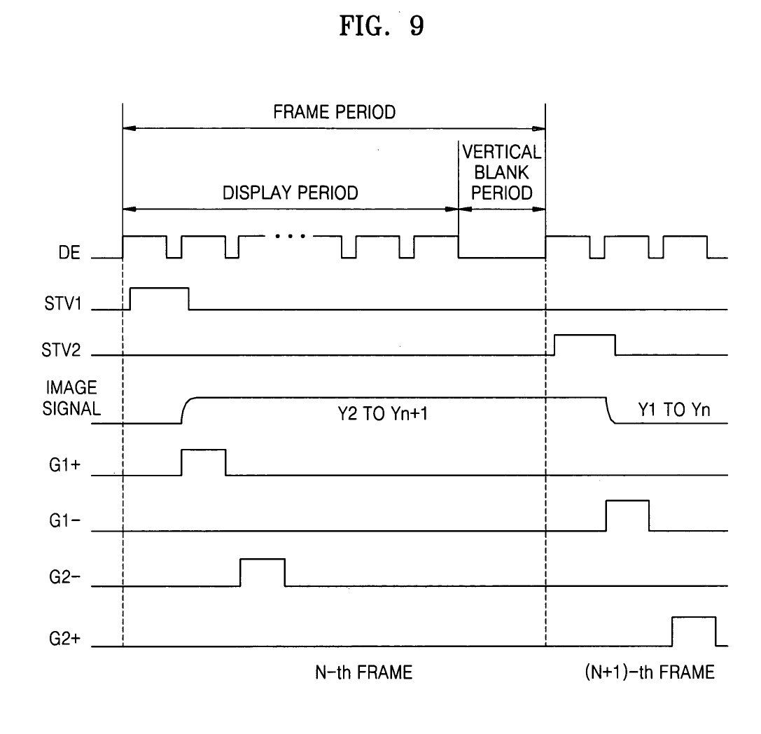

FIG. 9 is a timing diagram of signals used by the source driver 60 and the gate driver 80 operate according to an example embodiments of the present invention. Referring to FIG. 9, each frame period may include a display period and a vertical blank period. During the display period, pixels may be turned on by a data enable signal DE. If a first frame start signal STV1 is turned on in a N-th frame, the Y2 through Yn+1 source lines may be selected, so that the gate lines G1+, G2−, G3+, G4−, . . . , Gn− are sequentially turned on. In a (N+1) frame, if a second frame start signal STV2 is turned on, the Y1 through Yn source lines may be selected, so that the gate lines G1−, G2+, G3−, G4+, . . . , Gn+ are sequentially turned on.

Although example embodiments of the present invention disclose non-inversion dot driving, the teachings of example embodiments of the present invention may also be used with non-inversion row driving or non-inversion column driving.

While the present invention has been particularly shown and described with reference to example embodiments thereof, it will be understood by those of ordinary skill in the art that various changes in form and details may be made therein without departing from the spirit and scope of the present invention as defined by the following claims.

What is claimed is:

1. A source driver for driving a liquid crystal panel with a non-inversion output characteristic, comprising:
a non-inversion data register unit storing n image signals in response to first and second control signals; and
a non-inversion decoder unit decoding the n image signals and providing the decoded image signals to source lines of the liquid crystal panel.

2. The source driver of claim 1, further comprising a non-inversion level shifter for shifting a level of an output voltage of the non-inversion data register and providing a shifted result to the non-inversion decoder.

3. The source driver of claim 1, wherein the non-inversion data register unit stores the n image signals from a second non-inversion data register to a (n+1)-th non-inversion data register in response to the first control signal, and stores the n image signals from a first non-inversion data register to a n-th non-inversion data register in response to the second control signal.

4. The source driver of claim 1, wherein the non-inversion decoder unit includes a non-inversion decoder connected to each of the source lines, wherein each non-inversion decoder connected to an even source line decoded the n image signals with a first polarity voltage and each non-inversion decoder connected to an odd source lines decodes the n image signals with a second polarity voltage.

5. The source driver of claim 4, wherein the first polarity voltage is a voltage higher than an average voltage and the second polarity voltage is a voltage lower than the average voltage.

6. The source driver of claim 1, wherein a plurality of pixels are arranged in the liquid crystal panel, each pixel including TFT transistors whose drains are connected in common to a pixel electrode, whose sources are connected to the source lines, and whose gates are connected to corresponding gate lines, and wherein
different fixed image signals are applied to the source lines.

7. The source driver of claim 1, wherein each of the source lines are fixed as positive (+) or negative (−) source lines for an Nth, (N+1)th, . . . , frame.

8. The source driver of claim 1, wherein the source driver does not include a multiplexer.

9. The source driver of claim 8, wherein the source driver does not include a data multiplexer.

10. The source driver of claim 8, wherein the source driver does not include an output multiplexer.

11. A gate driver for driving a liquid crystal panel with a non-inversion output characteristic, comprising:
a non-inversion shift register unit storing first and second control signals; and
a non-inversion output buffer unit driving gate lines of the liquid crystal panel in response to the first control signal or the second control signal.

12. The gate driver of claim 11, further comprising a non-inversion level shifter for shifting a level of an output voltage of the non-inversion shift register unit and providing a shifted result to the non-inversion output buffer unit.

13. The gate driver of claim 11, wherein the first control signal and the second control signal are alternately stored in the non-inversion shift register unit for each frame which is displayed to the liquid crystal panel.

14. The gate driver of claim 11, wherein a plurality of pixels are arranged in the liquid crystal panel, each pixel including TFT transistors whose drains are connected in common to a pixel electrode, whose sources are connected to the source lines, and whose gates are connected to corresponding gate lines, and wherein different fixed image signals are applied to source lines.

15. The gate driver of claim 11, wherein the non-inversion output buffer unit provides two gate lines for each pixel of the liquid crystal panel, a gate line for providing only a positive (+) signal and a gate line for providing only a negative (−) signal.

16. The gate driver of claim 11, wherein the gate driver does not include a multiplexer.

17. The gate driver of claim 16, wherein the gate driver does not include a data multiplexer.

18. The gate driver of claim 16, wherein the gate driver does not include an output multiplexer.

19. A liquid crystal display device with a non-inversion output characteristic, comprising:
a liquid crystal panel including a plurality of source lines, a plurality of gate lines, and pixels located at intersections of the source lines and the gate lines; and
a non-inversion source driver supplying fixed image signals of different polarities to the source lines in response to a first control signal and a second control signal; and
a non-inversion gate driver driving the gate lines in response to the first control signal and the second control signal.

20. The liquid crystal display panel of claim 19, wherein each pixel includes TFT transistors whose drains are connected in common to a pixel electrode, whose sources are connected to the source lines, and whose gates are connected to the gate lines.

21. The liquid crystal display device of claim 19, wherein the non-inversion source driver includes:
a non-inversion data register unit storing n image signals in response to the first control signal and the second control signal; and
a non-inversion decoder unit decoding the n image signals and providing the decoded result to the source lines of the liquid crystal panel.

22. The liquid crystal display device of claim 21, wherein the non-inversion source driver further includes a non-inversion level shifter for shifting a level of an output voltage of the non-inversion data register unit and providing a shifted result to the non-inversion decoder unit.

23. The liquid crystal display device of claim 21, wherein the non-inversion data register stores the n image signals from a second non-inversion data register to a (n+1)-th non-inversion data register in response to the first control signal, and stores the n image signals from a first non-inversion data register to a n-th non-inversion data register in response to the second control signal.

24. The liquid crystal display device of claim 21, wherein the non-inversion decoder unit includes a non-inversion decoder connected to each of the source lines, wherein each non-inversion decoder connected to an even source line decodes the n image signals with a first polarity voltage and each non-inversion decoder connected to an odd source line decode the n image signals with a second polarity voltage.

25. The liquid crystal display device of claim 24, wherein the first polarity voltage is a voltage higher than an average voltage and the second polarity voltage is a voltage lower than the average voltage.

26. The liquid crystal display device of claim 21, wherein each of the source lines of the liquid crystal panel are fixed as positive (+) or negative (−) source lines for an Nth, (N+1)th, . . . , frame.

27. The liquid crystal display device of claim 19, wherein the non-inversion gate driver includes:
a non-inversion shift register unit storing the first and second control signals; and
a non-inversion output buffer unit driving the gate lines of the liquid crystal panel in response to the first control signal or the second control signal.

28. The liquid crystal display device of claim 27, wherein the non-inversion gate driver further includes a non-inversion level shifter for shifting a level of an output voltage of the non-inversion shift register unit and providing a shifted result to the non-inversion output buffer unit.

29. The liquid crystal display device of claim 27, wherein the first control signal and the second control signal are alternately stored in the non-inversion shift register unit for each frame which is displayed to the liquid crystal panel.

30. The liquid crystal display device of claim 27, wherein the non-inversion output buffer unit provides two gate lines for each pixel of the liquid crystal panel, a gate line for providing only a positive (+) signal and a gate line for providing only a negative (−) signal.

31. The liquid crystal display device of claim 19, wherein the non-inversion source driver does not include a multiplexer.

32. The liquid crystal display device of claim 31, wherein the non-inversion source driver does not include a data multiplexer.

33. The liquid crystal display device of claim 31, wherein the non-inversion source driver does not include an output multiplexer.

34. The liquid crystal display device of claim 19, wherein the non-inversion gate driver does not include a multiplexer.

35. The liquid crystal display device of claim 34, wherein the non-inversion gate driver does not include a data multiplexer.

36. The liquid crystal display device of claim 34, wherein the non-inversion gate driver does not include an output multiplexer.
